(19) United States
(12) Patent Application Publication
(10) Pub. No.: US 2025/0058250 A1
(43) Pub. Date: Feb. 20, 2025

(54) Concentric Sloping Plate Enhanced Vertical Compact Flotation Unit

(71) Applicant: Beijing Institute of Petrochemical Technology, Beijing (CN)

(72) Inventors: Guodong Ding, Beijing (CN); Jiayuan Zheng, Beijing (CN); Jianlong Hu, Beijing (CN); Jiaqing Chen, Beijing (CN); Yipeng Ji, Beijing (CN); Xiaolei Cai, Beijing (CN)

(21) Appl. No.: 18/680,422

(22) Filed: May 31, 2024

(30) Foreign Application Priority Data
Aug. 18, 2023 (CN) 202311040134.1

(51) Int. Cl. B01D 17/02; B01D 21/00; B01D 21/02; B01D 21/24; B01D 21/26; C02F 1/00; C02F 1/24; C02F 1/38; C02F 101/32; C02F 103/00; C02F 103/10; C02F 103/36

(52) U.S. Cl. CPC B01D 17/0214; B01D 17/0205; B01D 17/0217; B01D 21/0042; B01D 21/10; B01D 21/2411; B01D 21/267; C02F 1/24; C02F 1/38; C02F 2001/007; C02F 2101/32; C02F 2103/008; C02F 2103/10; C02F 2103/365

(57) ABSTRACT

The present disclosure provides a concentric sloping plate enhanced vertical compact flotation unit, relates to the technical field of oily waste water treatment, and is mainly used for efficient treatment of oily waste water such as oilfield produced water, refining and chemical waste water and tanker ballast water. The compact flotation unit includes a tank, an oil receiving structure, a swirling inner cylinder, a swirl breaking structure, a flow equalizing structure, sloping plate sedimentation components and a center cylinder. An exhaust port is formed in the top of the tank, a slag discharge port is formed in the bottom of the tank, and the side surface of the tank is provided with an oil spill port, a water outlet pipe and a water inlet pipe.

### CROSS REFERENCE TO RELATED APPLICATION

This application claims the benefit of and takes priority from Chinese Patent Application No. 202311040134.1 filed on Aug. 18, 2023, the contents of which are herein incorporated by reference

### TECHNICAL FIELD

The present disclosure relates to the technical field of oily waste water treatment, in particular to a concentric sloping plate enhanced vertical compact flotation unit.

### BACKGROUND

In 1970, the air flotation separation technology was first applied by Shell oil company to treat oily waste water so as to remove oil and some soluble pollutants in the waste water. Nowadays, the air flotation separation technology has been widely used in the field of oily waste water treatment all over the world. For the development trend of the main structure of an air flotation tank, the main structure is changed from a horizontal and open type to a vertical and closed type. At the same time, the main structure is integrated, coordinated and even coupled with other oil-water separation unit technologies to reduce the occupied area and unorganized emissions of VOCs (Volatile Organic Chemicals). Under the above background and the research concepts of “high efficiency of unit technology and compounding of unit technology”, many combined technologies for oily waste water treatment have been studied all over the world. What is remarkable is the compact flotation unit (CFU). At present, the CFU has the advantages of high treatment capacity, high separation efficiency, low operation cost and the like, and is widely used in offshore oilfield produced water treatment. However, the treatment capacity of oily waste water with high emulsification degree, high density and complex composition needs to be improved.

The united states patent US20110290738A introduces a single-tank and two-stage flotation tank. The waste water rich in fine bubbles enters the vertical outer cylinder through the water inlet to complete the first-stage separation in the first-stage separation cavity, and then enters the second-stage separation area through partition plates. The second-stage separation area is exactly the same as the first-stage separation area, and on this basis, three-stage and four-stage separation processes can be carried out as well. Through the structural style of the single-tank and multi-stage vertical outer cylinder, the structural compactness of the compact flotation unit is significantly improved while the oil removal efficiency is improved, and the occupied area of the compact flotation unit with large treatment capacity is greatly reduced. However, the internal structure of the flotation tank is complex, the hydraulic loss is large, and the installation and maintenance of various components are difficult.

The united states patent U.S. Pat. No. 7,157,007B2 introduces a vertical induced flotation tank. During the operation, oily waste water flows downwards to the bottom of the rectifier cylinder and is discharged into the treatment tank through circumferential liquid distribution ports. An agglomerated layer is arranged in the middle of the vertical outer cylinder. Through the agglomerated layer, small oil droplets are agglomerated larger, and the liquid distribution uniformity can also be enhanced. After passing through the agglomerated layer, the oily waste water carried with fine bubbles enters the air flotation cavity for air flotation. However, the internal structure of the flotation tank is complex, and the agglomerated layer is prone to be blocked under actual working conditions to affect the continuous production process.

The European patent WO2017/164747A1 introduces a multi-stage swirling flow technology with a multi-stage tangential inlet in a tank. When working, gas and oily waste water are fully mixed through the mixer and enter the compact flotation tank through the inlet pipeline, and the distribution pipes are uniformly distributed tangentially along the inner cone wall, so that flowing liquid forms clockwise and upward swirl movement. Water is screened out along the edge on the top, enters the outer cavity and flows to the bottom. The Stauper Water Technology patented guide vanes are installed between the inner cavity and the outer cavity on the top of the CFU, so that water flow changes from swirling flow to radial flow in direction. Under the effect of swirling flow, bubbles make full contact with droplets and large droplets and bubbles are agglomerated to move upward to the center, and oil and gas are discharged from the top. Solid impurities are deposited around the lower part of the inner cavity under the action of swirling flow, and are regularly discharged from below. However, the height-diameter ratio of the vertical outer cylinder of the device is small, and the compactness of the structure needs to be further improved.

A whirl microbubble flotation equipment is introduced by Tianjin Rigid Technology Co., Ltd. in the patent CN201932927U. During the working process, the oil-water mixture enters the device through the tangential inlet to form a swirling flow field, and the gas phase enters the equipment from the microporous tube at the bottom of the equipment to generate microbubbles through microporous foaming. The adherend formed by microbubbles and oil phase floats to the top of the equipment and is discharged through the oil drain port, and clear water is discharged from the bottom drain port. Because there is no special sand discharge port, oil sludge is easily accumulated at the bottom when the device is applied to the occasion with high sand concentration, so that the oil content of external drainage is higher.

A swirler and air flotation device is introduced by Jutal Offshore Oil Services Limited in patent CN202224253U. During the operation process, oily waste water enters the device through the tangential inlet in the middle and lower part of the device and then swirling flow is generated. Under the action of swirling centrifugal force, heavy water phase is thrown to the tank wall and enters the water collection chamber, and light bubbles and oil droplets move to the center of the vertical outer cylinder under the action of centrifugal force. The floating oil and escaping gas carried to the top liquid level by bubbles are discharged through the oil-gas outlet in the top of the device, and the oil droplets which are not carried to the liquid level by bubbles but are gathered close to the whirl centrifugal force are discharged through the oil pollution outlet in the bottom of the device.

### SUMMARY

The present disclosure aims to provide a concentric sloping plate enhanced vertical compact flotation unit so as to solve the technical problems that the compact flotation unit is large in occupied area, complicated in operation, high in operation and maintenance cost and low in oil-water separation efficiency in the prior art. Various technical effects generated by a preferred technical scheme in various technical schemes provided by the present disclosure are explained in detail as follow.

In order to achieve the above-mentioned purpose, the present disclosure provides the following technical scheme.

The present disclosure provides a concentric sloping plate enhanced vertical compact flotation unit, including a tank, an oil receiving structure, a swirling inner cylinder, a swirl breaking structure, a flow equalizing structure, sloping plate sedimentation components and a center cylinder. An exhaust port is formed in the top of the tank. A slag discharge port is formed in the bottom of the tank. The side surface of the tank is provided with an oil spill port, a water outlet pipe and a water inlet pipe. The oil spill port gets close to the top of the tank and communicates with the oil receiving structure. The water outlet pipe gets close to the bottom of the tank and is located below the center cylinder. The water inlet pipe is tangentially connected with the swirling inner cylinder. The center cylinder is vertically arranged, and the center cylinder sequentially passes through the sloping plate sedimentation components, the flow equalizing structure, the swirl breaking structure and the swirling inner cylinder from bottom to top and leads to the oil receiving structure. Oil receiving ports matched with the sedimentation components are formed in the center cylinder, and an oil phase separated by the sloping plate sedimentation components can enter the center cylinder through the oil receiving ports so that the oil phase floats upward in the center cylinder to the oil receiving structure.

Further, the swirl breaking structure includes swirl breaking plates, the swirl breaking plates are distributed at intervals along the circumferential direction of the center cylinder, and the swirl breaking plates are connected with the bottom of the swirling inner cylinder and the flow equalizing structure. A liquid-flow gap is formed between every two adjacent swirl breaking plates, and the direction of the liquid-flow gap is opposite to the swirling direction of incoming liquid in the swirling inner cylinder.

Further, the cross section of the swirl breaking plate is rhombic, and the ratio of the length of a long diagonal in the cross section of the swirl breaking plate to the inner diameter of the swirling inner cylinder is 0.04-0.08, the ratio of the length of a short diagonal in the cross section of the swirling to the inner diameter of the swirling inner cylinder is 0.05-0.09, and the acute angle of the swirl breaking plate is 30°-40°.

Further, the flow equalizing structure is of a frustum-shaped cylindrical structure, flow equalizing hole are formed in the flow equalizing structure, and the flow equalizing holes are distributed along the circumferential direction of the flow equalizing structure and in a plurality of turns along the radial direction of the flow equalizing structure.

Further, the flow equalizing structure is coaxially and fixedly connected with the swirling inner cylinder, and the aperture of the flow equalizing hole is 15 mm to 30 mm; and the inclination angle of the generatrix of the flow equalizing structure is 70°-90°.

Further, the center cylinder is located on a vertical central axis of the tank and coaxially arranged with the swirling inner cylinder and the sloping plate sedimentation components and the ratio of the diameter of the center cylinder to the swirling inner cylinder is 0.3-0.5.

Further, the sloping plate sedimentation component includes a plurality of conical sloping plates. The conical sloping plates are sequentially arranged at intervals along the height direction of the center cylinder. The conical sloping plate has a frustum-like outer contour.

Further, the sloping plate sedimentation components are located below the flow equalizing structure. The ratio of the total height of the sloping plate sedimentation components to the height of the tank is 0.4-0.5. The ratio of the height of a single conical sloping plate to the total height of the sloping plate sedimentation components is 0.15-0.2. The distance between every two adjacent conical sloping plates is 30 mm to 60 mm. The inclination angle of the generatrix of the conical sloping plate is 45°-65°.

Further, the oil receiving structure includes a bottom plate part and a side plate part. The bottom plate part is annular, and the outer circumferential side edge of the bottom plate part is connected with the inner side surface of the tank. The inner side edge of the bottom plate part is connected with the side plate part. An annular oil receiving tank is formed among the bottom plate part. The side plate part and the inner side surface of the tank. The diameter of the side plate part is larger than that of the swirling inner cylinder.

Further, water outlet holes are formed in the side plate part, the water outlet holes are arranged along the circumferential direction of the side plate part, and the water outlet holes get close to the bottom of the side plate part. The top edge of the side plate part is provided with sawteeth.

The preferred technical scheme of the present disclosure at least generates one of the following technical effects.

The concentric sloping plate enhanced vertical compact flotation unit provided by the present disclosure is based on the concept of unit technology compounding, which is embodied in the coupling inner cylinder internal rotation and sloping plate sedimentation technology. On one hand, the collision and adhesion probability between fine bubbles and dispersed phase oil droplets is effectively increased through the weak swirling flow field. On the other hand, the gravity separation process after the oil droplets are agglomerated is strengthened in a sloping plate sedimentation area, so that the collision and adhesion between oil droplets and bubbles are further promoted. In addition, a laminar flow environment is provided for the oil-water separation process by setting the swirl breaking structure and the flow equalizing structure, so that the oil-water separation process is further strengthened. According to the vertical compact flotation unit provided by the present disclosure, the single-cylinder and two-stage enhanced separation process can be completed through the synergistic effect of the swirling inner cylinder and the sloping plate sedimentation components, and the compact flotation unit has the characteristics of short hydraulic retention time, good oil-water separation effect and the like.

The collision and adhesion probability between fine bubbles and dispersed phase oil droplets is effectively increased by the straight swirling inner cylinder through the weak swirling flow field, so that large bubbles capable of destroying flotation can be separated, and small bubbles that are helpful to flotation process are reserved. In addition, due to different densities of phases in the incoming liquid, the incoming liquid can be preliminarily separated in the swirling area.

Through the vertical rhombic swirl breaking plate installed in the opposite direction to the swirling direction of the incoming liquid, formed swirling flow is reserved in the swirling inner cylinder to promote an irrotational environment for oil-water separation treated by the sloping plates.

The flow equalizing structure can realize the effect of flow equalizing.

Through the design of the multi-layer conical concentric sloping plate sedimentation components, the gravity separation process after oil droplets are agglomerated is strengthened by the formed sloping plate sedimentation area. At the same time, the migration time of oil droplets on the sloping plates is effectively increased, the collision and adhesion between oil droplets and bubbles are further promoted.

### BRIEF DESCRIPTION OF THE DRAWINGS

To describe the technical solutions in the embodiments of the present disclosure or in the prior art more clearly, the following briefly describes the attached figures required for describing the embodiments or the prior art. Apparently, the attached figures in the following description show merely some embodiments of the present disclosure, and a person of ordinary skill in the art may derive other drawings from these attached figures without creative efforts.

FIG. 1 is a structural schematic diagram of a vertical compact flotation unit provided by the present disclosure.

FIG. 2 is a longitudinal section view of a vertical compact flotation unit provided by the present disclosure.

FIG. 3 is a transverse section view of a vertical compact flotation unit provided by the present disclosure.

FIG. 4 is a top view of a swirl breaking structure provided in the present disclosure.

FIG. 5 is a top view of a flow equalizing structure provided in the present disclosure.

FIG. 6 is a transverse section view of a vertical compact flotation unit provided by the present disclosure.

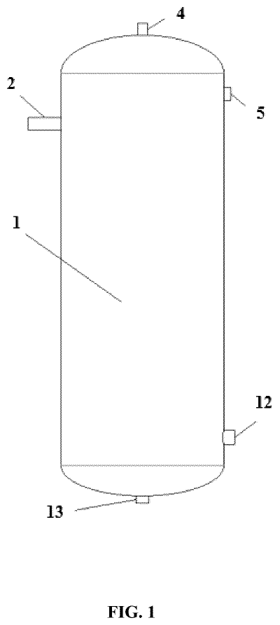

Reference signs: 1, tank; 2, water inlet pipe; 3, oil receiving structure; 301, bottom plate part; 302, side plate part; 303, annular oil receiving tank; 304, water outlet hole; 305, sawtooth; 4, exhaust port; 5, oil spill port; 6, swirling inner cylinder; 7, swirl breaking structure; 701, swirl breaking plate; 8, flow equalizing structure; 9, sloping plate sedimentation component; 901, conical sloping plate; 10, oil receiving port; 11, center cylinder; 12, water outlet pipe; and 13, slag discharge port.

### DETAILED DESCRIPTION OF THE EMBODIMENTS

In order to make the purpose, technical scheme and advantages of the present disclosure more clear, the technical scheme of the present disclosure is described in detail as follows. Apparently, the embodiments in the following description are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

The present disclosure provides a concentric sloping plate enhanced vertical compact flotation unit, including a tank 1, an oil receiving structure 3, a swirling inner cylinder 6, a swirl breaking structure 7, a flow equalizing structure 8, sloping plate sedimentation components 9 and a center cylinder 11. An exhaust port 4 is formed in the top of the tank 1. A slag discharge port 13 is formed in the bottom of the tank 1. The side surface of the tank 1 is provided with an oil spill port 5, a water outlet pipe 12 and a water inlet pipe 2. The oil spill port 5 gets close to the top of the tank 1 and communicates with the oil receiving structure 3. The water outlet pipe 2 gets close to the bottom of the tank 1 and is located below the center cylinder 11. The water inlet pipe 2 is tangentially connected with the swirling inner cylinder 6. The center cylinder 11 is vertically arranged, and the center cylinder 11 sequentially passes through the sloping plate sedimentation components 9, the flow equalizing structure 8, the swirl breaking structure 7 and the swirling inner cylinder 6 from bottom to top and leads to the oil receiving structure 3. Oil receiving ports 10 matched with the sedimentation components 9 are formed in the center cylinder 11, and an oil phase separated by the sloping plate sedimentation components 9 can enter the center cylinder 11 through the oil receiving ports 10 so that the oil phase floats upward in the center cylinder 11 to the oil receiving structure 3.

Oily waste water mixed with fine bubbles enters the swirling inner cylinder 6 from the tangential water inlet pipe 2 at the upper part of the equipment, and the oily waste water generates a weak swirling flow field in the swirling inner cylinder 6, so that the collision and adhesion probability between fine bubbles and dispersed phase oil droplets is effectively increased. An annular gap is formed between an upper end of the swirling inner cylinder 2 and the center cylinder 13, and gas and a small amount of oil phase move upward through the annular gap and enter the oil receiving structure 4.

A swirl breaking area consisting of the swirl breaking structure 7 is arranged below the swirling inner cylinder 6, and a fluid in the swirling inner cylinder 6 flows to the lower flow equalizing structure 8 through the swirl breaking structure 7. The swirl breaking structure 7 and the flow equalizing structure 8 provide a relatively stable flow field for the lower sloping plate sedimentation components 9, and the oil-water separation process in a sedimentation area of the sloping plate sedimentation components 9 is facilitated. Most of oil-water mixture flows to the sloping plate sedimentation components 9 through the flow equalizing structure 8, a sloping plate sedimentation area is formed in the tank 1 at the position of the sloping plate sedimentation components 9, and the gravity separation after the oil droplets are agglomerated is strengthened by the sloping plate sedimentation components 9. Oil receiving ports 10 are formed in the center cylinder 11 of the sloping plate sedimentation area, and the oil phase after sedimentation separation collides with and adheres to the fine bubbles again, and then floats up to the oil receiving structure 3 through the oil receiving ports 10. The oil phase in the oil receiving structure 3 can be discharged through the oil spill port 5, and a gas phase is collected on the top of the tank 1 and discharged through the exhaust port 4. Finally, purified waste water is discharged through the lower water outlet pipe 12, and impurities such as solid suspended matters are discharged through the bottom slag discharge port 13.

The vertical compact flotation unit provided by the present disclosure is based on the concept of unit technology compounding, which is embodied in the coupling inner cylinder internal rotation and sloping plate sedimentation technology. On one hand, the collision and adhesion probability between fine bubbles and dispersed phase oil droplets is effectively increased through the weak swirling flow field. On the other hand, the gravity separation process after the oil droplets are agglomerated is strengthened in the sedimentation area, so that the collision and adhesion between oil droplets and bubbles are further promoted. In addition, a laminar flow environment is provided for the oil-water separation process by setting the swirl breaking structure and the flow equalizing structure, so that the oil-water separation process is further strengthened. According to the vertical compact flotation unit provided by the present disclosure, the single-cylinder and two-stage enhanced separation process can be completed through the synergistic effect of the swirling inner cylinder and the sloping plate sedimentation components, and the compact flotation unit has the characteristics of short hydraulic retention time, good oil-water separation effect and the like.

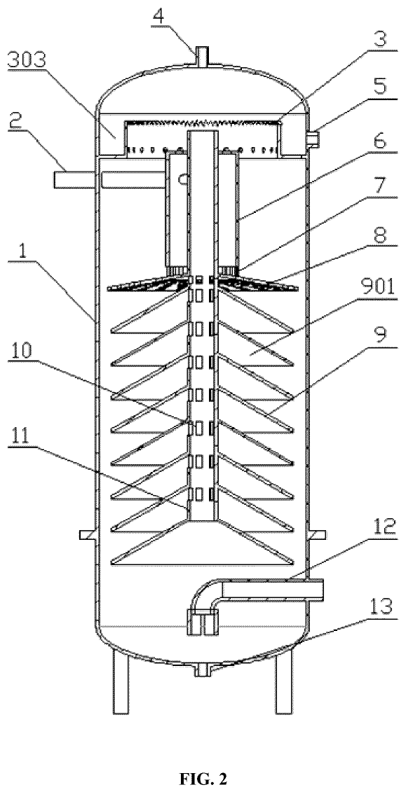

In addition, a connecting fixed structure is not schematically shown in FIG. 2, namely a structure for fixing the parts in the tank 1 inside the tank 1 is not schematically shown.

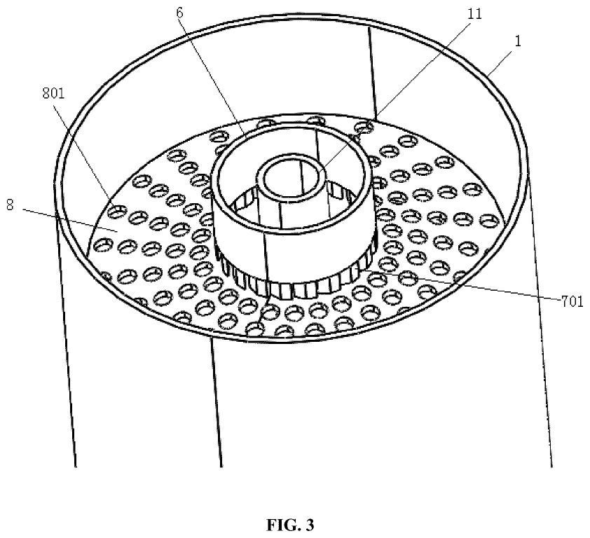

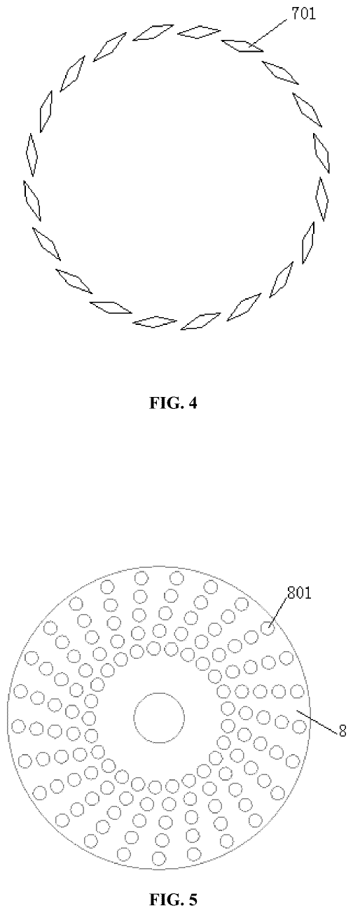

With respect to the swirl breaking structure 7, referring to FIG. 3 and FIG. 4, the swirl breaking structure 7 includes swirl breaking plates 701, the swirl breaking plates 701 are distributed at intervals along the circumferential direction of the center cylinder 11, and the swirl breaking plates 701 are connected with the bottom of the swirling inner cylinder 6 and the flow equalizing structure 8. A liquid-flow gap is formed between every two adjacent swirl breaking plates 701, and the direction of the liquid-flow gap is opposite to the swirling direction of incoming liquid in the swirling inner cylinder 6. The swirl breaking structure 7 is used for reserving swirling flow in the swirling inner cylinder 6 to provide the laminar flow environment for the oil-water separation process in the sloping plate sedimentation area.

Referring to FIG. 4, the cross section of the swirl breaking plate 701 is rhombic. In FIG. 4, a circumferential outlet formed between the adjacent swirl breaking plates 701 is anticlockwise, and the swirling flow of liquid in the swirling inner cylinder 6 is clockwise.

The swirl breaking plate 701 can be arranged as follows. The ratio of the length of a long diagonal in the cross section of the swirl breaking plate 701 to the inner diameter of the swirling inner cylinder 6 is 0.04-0.08, the ratio of the length of a short diagonal in the cross section of the swirl breaking plate 701 to the inner diameter of the swirling inner cylinder 6 is 0.05-0.09, and the acute angle of the swirl breaking plate 701 is 30°-40°, preferably 30°.

With respect to the flow equalizing structure 8, referring to FIG. 2, FIG. 3 and FIG. 5, the flow equalizing structure 8 of a frustum-shaped cylindrical structure. The flow equalizing structure 8 is coaxially and fixedly connected with the swirling inner cylinder 6. Flow equalizing holes 801 are formed in the flow equalizing structure 8. The flow equalizing holes 801 are distributed along the circumferential direction of the flow equalizing structure 8 and in a plurality of turns along the radial direction of the flow equalizing structure 8. The flow equalizing structure 8 can realize the effect of flow equalizing.

With respect to the size of the flow equalizing hole 801, the aperture of the flow equalizing hole 801 can be set to be 15 mm to 30 mm. The inclination angle of the generatrix of the flow equalizing structure 8 is 70° to 90°, preferably 80°.

With respect to the center cylinder 11, the center cylinder 11 is located on a vertical central

axis of the tank 1 and coaxially arranged with the swirling inner cylinder 6 and the sloping plate sedimentation components 9. Referring to FIG. 2, the swirling inner cylinder 6 is schematically shown. The swirling inner cylinder 6 is of a cylindrical structure, and the diameter of the swirling inner cylinder 6 is larger than that of the center cylinder 11. The top of the swirling inner cylinder 6 is also provided with a circular plate. The outer circumferential side edge of the circular plate is connected with the top edge of the swirling inner cylinder 6. The diameter of an inner hole of the circular plate is larger than that of the center cylinder 11. The center cylinder 11 penetrates through the circular plate and leads to the oil receiving structure 3. The distance between the inner hole of the circular plate and the center cylinder 11 is 5 mm to 10 mm.

With respect to the size of the center cylinder 11, preferably, the ratio of the diameter of the center cylinder 11 to the swirling inner cylinder 6 is 0.3-0.5.

With respect to the sloping plate sedimentation components 9, the specific structure is as follows. The sloping plate sedimentation component 9 includes a plurality of conical sloping plates 901. The conical sloping plates 901 are sequentially arranged at intervals along the height direction of the center cylinder 11. The conical sloping plate 901 has a frustum-like outer contour. Referring to FIG. 2 the distribution of the conical sloping plates 901 on the center cylinder 11 is schematically shown.

The sloping plate sedimentation components 9 are located below the flow equalizing structure 8. The ratio of the total height of the sloping plate sedimentation components 9 to the height of the tank 1 is 0.4-0.5. The ratio of the height of a single conical sloping plate 901 to the total height of the sloping plate sedimentation components 9 is 0.15-0.2. The distance between every two adjacent conical sloping plates 901 is 30 mm to 60 mm. The inclination angle of the generatrix of the conical sloping plate 901 is 45°-65°.

The oil receiving ports 10 are formed in the center cylinder 11 and located between two corresponding conical sloping plates 901, and a plurality of oil receiving ports 10 are distributed at intervals along the circumferential direction of the center cylinder 11. For example, six oil receiving ports 10 are formed around the center cylinder 11, and the ratio of the length of the oil receiving port 10 to the distance between the conical sloping plates 901 is 0.25-0.75.

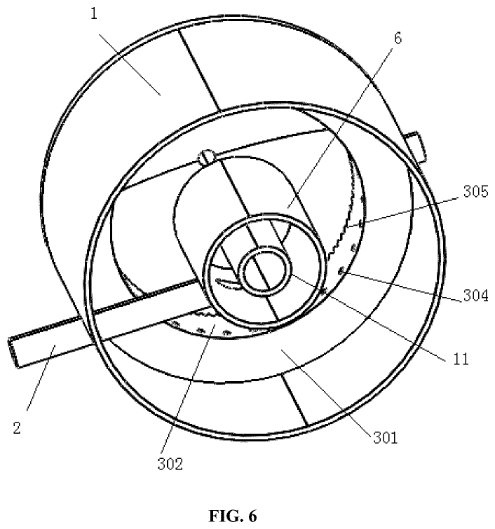

With respect to the oil receiving structure 3, referring to FIG. 2 and FIG. 6, the oil receiving structure 3 includes a bottom plate part 301 and a side plate part 302. The bottom plate part 301 is annular, and the outer circumferential side edge of the bottom plate part 301 is connected with the inner side surface of the tank 1. The inner side edge of the bottom plate part 301 is connected with the side plate part 302. An annular oil receiving tank 303 is formed among the bottom plate part 301, the side plate part 302 and the inner side surface of the tank 1. The diameter of the side plate part 302 is larger than that of the swirling inner cylinder 6. Referring to FIG. 2, the positional relationship between the center cylinder 11 and the oil receiving structure 3 is schematically shown.

Water outlet holes 304 are formed in the side plate part 302. The water outlet holes 304 are arranged along the circumferential direction of the side plate part 302. The water outlet holes 304 get close to the bottom of the side plate part 302. An extremely small amount of water phase is discharged through the water outlet holes 304 inside the annular oil receiving tank 303. The top edge of the side plate part 302 is provided with sawteeth 305.

In the description of the present disclosure, it needs to be illustrated that, except as otherwise noted, the meaning of “a plurality of” is two or more than two; and the indicative direction or position relations of the terms such as “upper”, “lower”, “left”, “right”, “inside”, “outside”, “front end”, “rear end”, “head” and “tail” are direction or position relations illustrated based on the accompanying diagrams, just for facilitating the description of the present disclosure and simplifying the description, but not for indicating or hinting that the indicated device or element must be in a specific direction and is constructed and operated in the specific direction, the terms cannot be understood as the restriction of the present disclosure. Moreover, the terms such as “first”, “second”, and “third” are just used for distinguishing the description, but cannot be understood to indicate or hint relative importance.

In the description of the present disclosure, it further needs to be illustrated that, except as otherwise noted, the terms such as “mount”, “link” and “connect” should be generally understood. For example, the components can be fixedly connected, and also can be detachably connected or integrally connected; the components can be mechanically connected, and also can be electrically connected; and the components can be directly connected, and also can be indirectly connected through an intermediate. For those skilled in the art, the specific meanings of the terms in the present disclosure can be understood according to specific conditions.

In the description of the specification, the description of the reference terms such as “one embodiment”, “some embodiments”, “examples”, “specific examples” or “one example” indicates to be contained in at least one embodiment or example of the disclosure in combination with specific characteristics, structures, materials or characteristics described by the embodiment or example. In the specification, schematic expression of the above terms does not necessarily refer to the same embodiment or example. Moreover, the described specific features, structures, materials or characteristics can be combined in any of one or more embodiments or examples appropriately.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A concentric sloping plate enhanced vertical compact flotation unit, comprising a tank (1), an oil receiving structure (3), a swirling inner cylinder (6), a swirl breaking structure (7), a flow equalizing structure (8), sloping plate sedimentation components (9) and a center cylinder (11), wherein
an exhaust port (4) is formed in the top of the tank (1), a slag discharge port (13) is formed in the bottom of the tank (1), the side surface of the tank (1) is provided with an oil spill port (5), a water outlet pipe (12) and a water inlet pipe (2), the oil spill port (5) gets close to the top of the tank (1) and communicates with the oil receiving structure (3), the water outlet pipe (2) gets close to the bottom of the tank (1) and is located below the center cylinder (11), and the water inlet pipe (2) is tangentially connected with the swirling inner cylinder (6);
the center cylinder (11) is vertically arranged, and the center cylinder (11) sequentially passes through the sloping plate sedimentation components (9), the flow equalizing structure (8), the swirl breaking structure (7) and the swirling inner cylinder (6) from bottom to top and leads to the oil receiving structure (3);
an oil receiving port (10) matched with the sedimentation component (9) is formed in the center cylinder (11), and an oil phase separated by the sloping plate sedimentation components (9) can enter the center cylinder (11) through the oil receiving port (10) so that the oil phase floats upward in the center cylinder (11) to the oil receiving structure (3).

2. The concentric sloping plate enhanced vertical compact flotation unit according to claim 1, wherein the swirl breaking structure (7) comprises swirl breaking plates (701), the swirl breaking plates (701) are distributed at intervals along the circumferential direction of the center cylinder (11), and the swirl breaking plates (701) are connected with the bottom of the swirling inner cylinder (6) and the flow equalizing structure (8);
a liquid-flow gap is formed between every two adjacent swirl breaking plates (701), and the direction of the liquid-flow gap is opposite to the swirling direction of incoming liquid in the swirling inner cylinder (6).

3. The concentric sloping plate enhanced vertical compact flotation unit according to claim 2, wherein the cross section of the swirl breaking plate (701) is rhombic, and the ratio of the length of a long diagonal in the cross section of the swirl breaking plate (701) to the inner diameter of the swirling inner cylinder (6) is 0.04-0.08, the ratio of the length of a short diagonal in the cross section of the swirling (701) to the inner diameter of the swirling inner cylinder (6) is 0.05-0.09, and the acute angle of the swirl breaking plate (701) is 30°-40°.

4. The concentric sloping plate enhanced vertical compact flotation unit according to claim 1, wherein the flow equalizing structure (8) is of a frustum-shaped cylindrical structure, flow equalizing holes (801) are formed in the flow equalizing structure (8), and the flow equalizing holes (801) are distributed along the circumferential direction of the flow equalizing structure (8) and in a plurality of turns along the radial direction of the flow equalizing structure (8).

5. The concentric sloping plate enhanced vertical compact flotation unit according to claim 4, wherein the flow equalizing structure (8) is coaxially and fixedly connected with the swirling inner cylinder (6), and the aperture of the flow equalizing hole (801) is 15 mm to 30 mm; and the inclination angle of the generatrix of the flow equalizing structure (8) is 70°-90°.

6. The concentric sloping plate enhanced vertical compact flotation unit according to claim 1, wherein the center cylinder (11) is located on a vertical central axis of the tank (1) and coaxially arranged with the swirling inner cylinder (6) and the sloping plate sedimentation components (9), and the ratio of the diameter of the center cylinder (11) to the swirling inner cylinder (6) is 0.3-0.5.

7. The concentric sloping plate enhanced vertical compact flotation unit according to claim 1, wherein the sloping plate sedimentation component (9) comprises a plurality of conical sloping plates (901), the conical sloping plates (901) are sequentially arranged at intervals along the height direction of the center cylinder (11), and the conical sloping plate (901) is cylindrical in structure and has a frustum-like outer contour.

8. The concentric sloping plate enhanced vertical compact flotation unit according to claim 7, wherein the sloping plate sedimentation components (9) are located below the flow equalizing structure (8), the ratio of the total height of the sloping plate sedimentation components (9) to the height of the tank (1) is 0.4-0.5, the ratio of the height of a single conical sloping plate (901) to the total height of the sloping plate sedimentation components (9) is 0.15-0.2, the distance between every two adjacent conical sloping plates (901) is 30 mm to 60 mm, and the inclination angle of the generatrix of the conical sloping plate (901) is 45°-65°.

9. The concentric sloping plate enhanced vertical compact flotation unit according to claim 1, wherein the oil receiving structure (3) comprises a bottom plate part (301) and a side plate part (302), the bottom plate part (301) is annular, and the outer circumferential side edge of the bottom plate part (301) is connected with the inner side surface of the tank (1), the inner side edge of the bottom plate part (301) is connected with the side plate part (302), an annular oil receiving tank (303) is formed among the bottom plate part (301), the side plate part (302) and the inner side surface of the tank (1), and the diameter of the side plate part (302) is larger than that of the swirling inner cylinder (6).

10. The concentric sloping plate enhanced vertical compact flotation unit according to claim 9, wherein water outlet holes (304) are formed in the side plate part (302), the water outlet holes (304) are arranged along the circumferential direction of the side plate part (302), and the water outlet holes (304) get close to the bottom of the side plate part (302); and the top edge of the side plate part (302) is provided with sawteeth (305).
